(19) United States
(12) Patent Application Publication
(10) Pub. No.: US 2023/0206599 A1
(43) Pub. Date: Jun. 29, 2023

(54) SYSTEMS AND METHODS FOR MEDIA BOUNDARY DETECTION

(71) Applicant: VIZIO, INC., Irvine, CA (US)

(72) Inventors: Ridhima Singla, Fremont, CA (US); Samuel Ellgass, Berkeley, CA (US); Evan McNeal, Denver, CO (US)

(73) Assignee: VIZIO, INC., Irvine, CA (US)

(21) Appl. No.: 18/089,452

(22) Filed: Dec. 27, 2022

Related U.S. Application Data
(60) Provisional application No. 63/294,319, filed on Dec. 28, 2021.

(51) Int. Cl. G06V 10/74; H04N 21/485; G06V 10/44

(52) U.S. Cl. CPC G06V 10/761; H04N 21/4852; H04N 21/4854; G06V 10/44

(57) ABSTRACT

Systems and method are provided for detecting the boundaries of media relative to linear media programming. A display device may receive a first cue from a first video frame of media being presented by a display device and generate, using a trained machine-learning model and the first cue, a first prediction of a first content type represented by the first video frame. The display device may subsequently receive a second cue from a second video frame of media being presented by the display device and generate a second prediction of a second content type represented by the second video frame. The display device can determine a probability that the first content type does not match the second content type based on the first prediction and the second prediction thereby identifying a boundary between different media being presented by the display device.

### CROSS-REFERENCE TO RELATED APPLICATIONS

The present patent application claims the benefit of priority to U.S. Provisional Patent Application No. 63/294,319 filed Dec. 28, 2021, which is incorporated herein by reference in its entirety for all purposes.

### TECHNICAL FIELD

This disclosure relates generally to media boundary detection, and more particularly to detecting media boundaries relative to linear media programming.

### BACKGROUND

The analysis of home television viewing has been ongoing since the original Nielsen TV ratings became a foundational statistic of audience measurement, impacting advertising rates and television series renewals. The progression of audience measurement improvements has followed both improvements in technology in the home, as well as the growth of the Internet. Modern audience measurements include media consumption extending far beyond traditional broadcast television, and now include mobile devices and laptops. A significant challenge in identifying video programming, is the multitude of consumer devices now associated with or attached to the TV, including video game consoles where the displayed video from the games being played can corrupt the audience measurement systems. Video game attribution is becoming increasingly relevant to retarget content distribution based on specific game sessions, linking certain commercial message viewings to video game playing, creating audience segments for gamers, etc.

### SUMMARY

Methods and systems are described herein for media boundary detection. The method may include: receiving a first cue from one or more frames of video of media being presented by a display device, wherein the first cue includes a set of features derived from the one or more frames of video; generating, using a trained machine-learning model and the first cue, a first prediction of a first content type represented by the one or more frames of video; receiving a second cue from one or more subsequent frames of video being presented by the display device, wherein the second cue is received after the first cue; generating, using the trained machine-learning model and the second cue, a second prediction of a second content type represented by the one or more frames of video; determining, based on the first prediction and the second prediction, a probability that the first content type does not match the second content type; and executing a function of the display device based on the probability that the first content type does not match the second content type.

The systems described herein are used for media boundary detection. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of example components connected to a display device for which boundary detection may be performed system according to aspects of the present disclosure.

FIG. 2 illustrates a block diagram of an example computing device configured to detect boundaries associated with content being presented by a display device according to aspects of the present disclosure.

FIG. 3A is a graph of random forest ROC of Test 1 according to aspects of the present disclosure.

FIG. 3B is a graph of a logistics regression ROC of Test 2 according to aspects of the present disclosure.

FIG. 3C is a graph of ensemble ROC on Test 1 according to aspects of the present disclosure.

FIG. 4A-C illustrate histogram graphs of the distribution of distance from mean for different video games according illustrate to aspects of the present disclosure.

FIGS. 5A and 5B illustrate an example Ensemble Model (smoothed) and Rolling Average Model (smoothed) respectively according to aspects of the present disclosure.

FIGS. 5C and 5D Ensemble Model ROC Curve and a Rolling Average Model ROC Curve respectively according to aspects of the present disclosure.

FIG. 6 illustrates a block diagram of a boundary detection system configured to detect boundaries between media of a first type and media of a second type according to aspects of the present disclosure.

FIG. 7 illustrates a flowchart of an example process for detecting boundaries relative to linear programming according to aspects of the present disclosure.

FIG. 8 illustrates an example computing device architecture of an example computing device that can implement the various techniques described herein according to aspects of the present disclosure.

### DETAILED DESCRIPTION

Display devices may receive media from a variety of sources such as broadcast media (e.g., television programming over-the-air (OTA) or via cable box), local or remote memory (e.g., such as media stored within memory, streaming media, etc.), one or more connected devices (e.g., video game consoles, devices configured to present locally stored or streaming media, Digital Video Disk players, other media players, etc.), and the like. Display devices may monitor input sources to distinguish content being presented from an OTA source from content being presented from an input source (e.g., such as a High-Definition Multimedia Interface (HDMI) input, a DisplayPort input, a Universal Serial Bus (USB) input, etc.). However, display devices cannot determine what type of content is being presented from an input source or identify the particular content being presented.

The present disclosure includes systems and methods for detecting boundaries between media types presented by a display device. A boundary may occur when a display device switches from presenting a media of a first type to presenting media of a second type. For example, a boundary may occur when a display device may switch from presenting stream media to a video game. The methods and systems described herein can detect a first boundary when the presentation of the video game media begins and detect a second boundary when the video game media terminates (e.g., such as when the display device switches to another input source, broadcast media, back to streaming media, when the display device is switched off, etc.). The display device may distinguish between any type of media (e.g., television shows, movies, commercials, video games, streaming media, etc.) using processes that are executed locally by the display device. The display device may also identify the particular media that is being presented by the display device using local and/or remote processes.

In some examples, a display device may receive a cue that represents one or more frames of video. A cue may include characteristics of the one or more frames of video and, in some instances, characteristics of an audio component that corresponds to the one or more frames of video. The display device may extract one or more sets of features from the cue and generate a corresponding one or more feature vectors. The one or more features may include video features (e.g., pixel values, etc.), The display device may execute a first machine-learning model using the one or more feature vectors to generate a prediction corresponding to a content type of the media represented by the one or more frames of video. Examples of content type include, but are not limited to, movie, televisions show, streaming media, advertisement or commercial, video game, music (e.g., with or without a video component), and the like. In some instances, the display device may generate predictions in regular intervals, periodically, in response to detecting an event, etc.

In some instances, each time the first machine-learning model generates a prediction corresponding to a new content type (e.g., different from the content type of the immediately preceding prediction) with a confidence that is greater than a threshold, the display device may store a timestamp. The timestamp may be recorded with an identification of the new content type. The display device may determine that during the time interval from a first timestamp (e.g., stored when the display device was switched on or shortly thereafter) to a second timestamp the display device was presenting a content corresponding to the new content type. Each subsequent timestamp may be paired with the immediately preceding timestamp to identify the content type being presented between each pair of timestamps.

In some instances, the display device may identify the ending boundary (e.g., the frame of video in which the display device switches to content corresponding to a different content type than the preceding frame of video) using a second machine-learning model. For instance, the second machine-learning model may be a Rolling Average Classifier that analyzes the current cue and one or more previous cues to determine a probability that that the current cue was derived from a frame of video presenting content of a same type or content of a different type. The Rolling Average Classifier may be a non-Bayesian machine-learning model that defines a mean from the features of a set of cues received over a lookback window (e.g., a window beginning at a current time and extending backwards by a predetermined time interval). In some instances, the mean may be defined from a set of cues. In other instances, a mean may be defined for each feature of a cue (e.g., such that a plurality of mean values may be generated). The Rolling Average Classifier may then determine a Euclidean distance of the features of a current cue from the mean value (or values). Using z-score (e.g., a fractional representation of standard deviations from the mean value or values) and the lookback window, the Rolling Average Classifier generates a probability that the features of the current cue the end-of-session reading. Alternatively, using z-score and the lookback window, the Rolling Average Classifier may generate a probability for each feature of a current cue, where the probability indicates a likelihood that the feature is indicative of a boundary (i.e., that the content presented in the current frame of video is of a different type than content presented in the video frame from which a previous cue was received).

The display device may define a size of the lookback window based on one or more target accuracy metrics (e.g., accuracy, precision, area under the curve, logarithmic loss, F 1 score, mean absolute error, mean square error, etc.) for the first machine-learning model and/or the second machine-learning model, characteristics of the cues, characteristics of predictions generated by the first machine-learning model and/or the second machine-learning model, a frequency with which cues are received by the display device, a frequency with which predictions are generated by the first machine-learning model and/or the second machine-learning model, characteristics of the video frames being analyzed, a predetermined time interval, combinations thereof, or the like. In some examples, the lookback window may have a size so as to include a predetermined quantity of cues.

The size of the lookback window may be modified to increase the accuracy of predictions generated by the Rolling Average Classifier (e.g., by increasing the length of the window so as to include more cues) at the expense of increase processing resources used to generate the predictions. The size of the lookback window may be modified to decrease the processing resources used by the display device to generate predictions (e.g., by decreasing the length of the window so as to include fewer cues to analyze) at the expense of the accuracy of predictions generated by the Rolling Average Classifier. The display device may dynamically increase or decrease the display window based on a current state of the display device, current processing load of the processing resources of the display device, threshold accuracy of the Rolling Average Classifier, user input, time, a time interval since a previous prediction, a time interval since a previous prediction indicated a boundary, combinations thereof, or the like.

The lookback window may be a rolling window such that with each new cue contributing to the mean value (or values), the oldest cue that contributed to the mean value (values) is removed so as to no longer contribute to the mean value (or values). The rolling window reduces the susceptibility of the mean value (or values) to noise or from becoming useless. For example, if the rolling window was static and was calculated from cues corresponding to too many different content types, than any new cue may appear as if corresponding to a new content type, thus introducing error. In some instances, the mean value (or values) may be recalculated each time a new cue corresponding to a different content type than a previous cue.

The display device may include a monitoring class configured to manage the operations of Rolling Average Classifier and process the output. For example, a session object may initiate execution of the Rolling Average Classifier based on initialization parameters passed into the session object. The object may output video frame identifiers corresponding to the most recent video frame processed until HasSessionEnded function returns true (e.g., indicating that Rolling Average Classifier has detected a boundary that corresponds to a prediction that the current frame corresponds to content of a different type than preceding frames). The session object may retain the identifier of the last video frame, which corresponds to the first video frame of content corresponding to the different type.

The identifier of the last video frame can be retrieved via the function RetrieveSessionEnd. A Reset function can reinitialize the Rolling Average Classifier using the initialization parameters, allowing the same model to be used again for attributing a different session. A loop may be defined to cause the session object to be reanalyzed each time a boundary video frame is detected to continuously detect boundaries and content types within media being presented by the display device.

The display device may execute one or more functions upon detecting a boundary (e.g., with a prediction that is greater than a threshold and/or upon generating two or more predictions that corresponding to content of same content type after a boundary, etc.). The one or more functions may be executed each time is boundary is detected, when the first machine-learning model and/or the second machine-learning model indicate that a cue represents content of a particular content type, when content is identified, upon generating two consecutive boundaries usable to indicate a time interval over which the display device has predicted content of a particular content type is being presented, combinations thereof, or the like.

The one or more functions may include, but are not limited to: modifying one or more settings of the display device based on the display device predicting that content being presented corresponds to a particular content type (e.g., to improve presentation of content of the particular content type, etc.), storing or transmitting an indication of the prediction of the display device that indicates the content being presented corresponds to a particular content type, storing or transmitting a time interval over which the display device predicts the content being presented corresponds to a particular content type, identifying content being presented by the display device (e.g., by matching one or more cues corresponding to content being presented to reference cues stored in local or remote memory, etc.), combinations thereof, or the like.

In an illustrative example, a display device may receive a first cue representing one or more frames of video of media being presented by the display device. The display device may define a set of features extracted from the first cue. The set of features may represent characteristics of the one or more frames of video and/or characteristics of an audio segment corresponding to the one or more frames of video. In some instances, the display device may include a frame buffer as part of the processing pipeline of the display device. The display device may identify a particular one or more frames of video from the frame buffer and generate the cue from the one or more frames of video. Alternatively, the display device may receive the cue from a component of the display device (e.g., such an integrated system-on-a-chip (SOC), a device connected to the display device, a process executed by the display device, a process executed by another device connected to the display device, a remote process (e.g., executed by a server, via cloud network or service, etc.), from local or remote memory, and/or the like.

The display device may execute a machine-learning model using the first cue. For example, the display device may define one or more feature vectors from the first cue and execute the machine-learning model using the one or more feature vectors as input. The machine-learning model may generate a prediction of a content type (e.g., video game, television show, movie, a streaming service, an advertisement or commercial, music, etc.) corresponding to the media being presented by the display device. The machine-learning model may also generate, with each prediction, a corresponding confidence value indicative of a degree the feature vector(s) of the first cue corresponds to the predicted output. The confidence value may be indicative of a probability in which the prediction is accurate. In instances in which the machine-learning model generates multiple predictions for an input cue, the display device may select the prediction with a highest corresponding confidence value to be the output prediction.

The machine-learning model may be, but is not limited to, a clustering model (e.g., Naïve Bayes, K-Means, Mean-Shift, Density-Based Spatial Clustering, Gaussian Mixture Models, Agglomerative Hierarchical Clustering, etc.), a random forest model, a Rolling Average Classifier, support vector machine, Naïve Bayes, a logistic regression model, and an ensemble model including logistic regression model(s) and random forest model(s), neural network (e.g., a convolutional neural network, recurrent neural network, deep neural network), a deep learning network, etc. The machine-learning model may be trained using supervised learning, unsupervised learning, semi supervised learning, reinforcement learning, or the like based on the particular machine-learning model to be used, a type of output expected, and/or a target accuracy of the machine-learning model.

The machine-learning model may be trained using cues received from a reference database (e.g., with labels for supervised learning or un-labeled for unsupervised learning). Alternatively, the machine-learning model may be trained using cues received from media presented by the display device over time. The machine-learning model may be trained (via a background process of the display device) for a predetermined time interval or until a target accuracy is reached. Once trained, the machine-learning model may begin generating predictions. In some examples, the machine-learning model may be trained remotely (e.g., by a server, another display device, etc.) and stored within memory of the display device during manufacturing or downloaded into memory of the display device.

In some examples, the display device may execute one or more functions (as previously described) based on the particular predicted content type. For example, the display device may transmit a communication to a content server indicating that the display device is present content of a particular content type. Alternatively, or additionally, the display device may modify the display device to improve presentation of content corresponding to the display type. For instance, if the display device is presenting video game content, then the display device may increase the frame rate or response time of the display device to improve appearance of the display device and ability of a user to interact with the video game. If the display device is presenting music or streaming content, the display device may reduce the frame rate to reduce processing resource consumption.

The display device may receive a second cue representing one or more subsequent frames of video displayed by the display device. The one or more subsequent frames of video may be presented at some time instant after the one or more video frames. For example, the display device may receive cues in periodically, in regular intervals, upon detection of an event (e.g., such as activation of a control of the display device, receiving instructions from a remote control, when the display device switches to an input source such as HDMI, when the display device is presented content from an input source, detection of a boundary, etc.), etc. When cues are received in regular intervals (e.g., 1 second, 5 seconds, 10 seconds, etc.), the display device may receive cues corresponding to one or more frames that are separated by the regular interval length.

In some instances, the display device may modify the regular interval (referred to as the modified time interval). For example, when an event is detected (e.g., such as activation of a control of the display device, receiving instructions from a remote control, when the display device switches to an input source such as HDMI, when the display device is presented content from an input source, detection of a boundary, etc.), the display device may increase the rate in which cues are received for a predetermined time interval such as that if the display device regularly receives cues ever 5 seconds, then in response detecting an event, the display device may receive cues every second for the next predetermined time interval (e.g., 30 seconds, 1 minute, etc.). The regular time interval and the modified time interval may be predetermined or selected based on user input, the machine-learning model, the type of event detected, the content type currently being presented, and/or the like.

The display device may generate a second prediction of a second content type represented by the one or more frames of video using the machine-learning model and the second cue. In some instances, the display device may generate the prediction using a second machine-learning model in addition to or in place of the machine-learning model. The second machine-learning model may, for example, be a Rolling Average Classifier that uses naïve clustering to determine whether a new cue is distinct from (and therefor represents content of a different content type) previous cues. For example, the Rolling Average Classifier may define a mean value from a set of cues (or a mean value for each feature derived from each cue of the set of cues). The Rolling Average Classifier then determines for each new cue, the Euclidean distance the new cue is from the mean value (or values). A probability (e.g., confidence value, etc.) may be calculated that the new cue was obtained from a frame that corresponds to content of a different content type than the frames that correspond to the cues used to derive the mean value. The probability may be calculated based on the Euclidean distance or from z-score derived from the Euclidean distance. The probability may then be used to generate a prediction of whether the new cue was obtained from a frame representing content of a same type or a different type from previous frames. For example, if the probability is greater than a threshold, then then the Rolling Average Classifier may predict that the new cue corresponds to a frame representing content of a new content type.

The display device may determine, based on the first prediction and the second prediction, a probability that the first content type does not match the second content type. The display device may determine the probability that first content type does not match the second content type by comparing the first prediction to the second prediction and, in some instances, the confidence value corresponding to the first prediction and the confidence value corresponding to the second prediction.

The display device may execute one or more functions based on the probability that first content type does not match the second content type. The display device may execute any function (e.g., as previously described). In some instances, the particular one or more functions executed may be based on the particular content type associated with the probability. In other instances, the display device may select the one or more functions based on the particular content type associated with the probability and one or more of: characteristics of the machine-learning model (and/or second machine-learning model, predictions (or confidences or probabilities) generated by the machine-learning model (and/or the second machine-learning model), characteristics of the display device (e.g., a currently selected input source, input from a remote control, user input, settings of the display device, etc.), an identification of a preceding content type presented by the display device, historical content types presented by the display device, etc.).

In some instances, the display device may store a timestamp corresponding to each prediction that corresponds to a new content type. The display device may then determine a time interval over which content type was presented by the display device. The display device may transmit a report to a content server indicating one or more content types presented by the display device (e.g., a current content type and/or one or more immediately preceding content types, historical content types, etc.) along with the time interval corresponding to each content type.

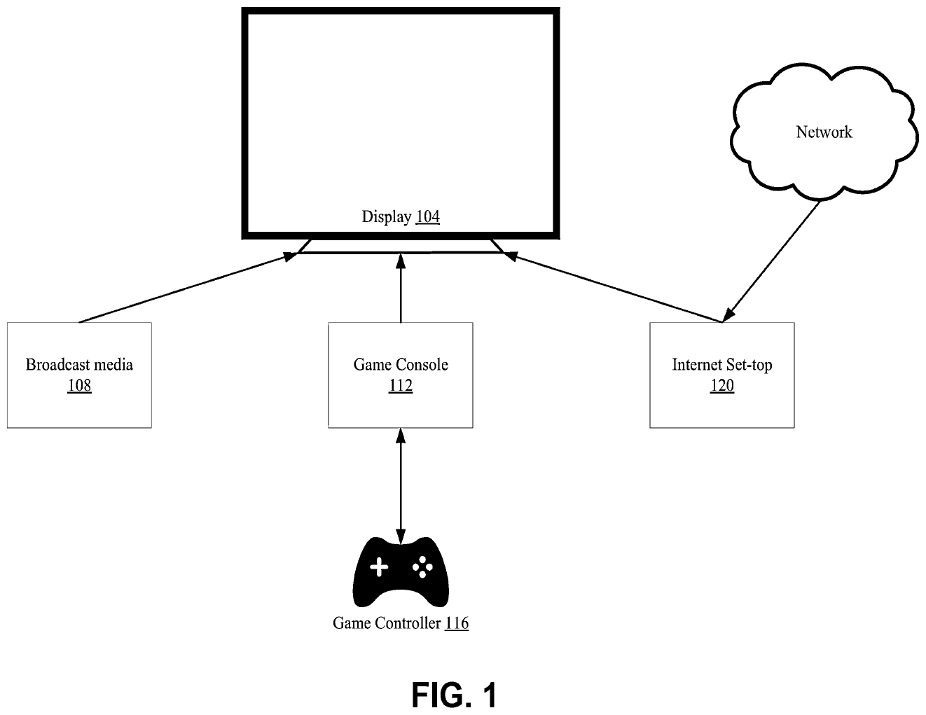

FIG. 1 illustrates a block diagram of an example components connected to a display device for which boundary detection may be performed system according to aspects of the present disclosure. Displays device 104 may be a device configured to display media (e.g., audio and/or video) from connected devices, from the Internet (e.g., streaming media, downloaded media, etc.), and/or the like. Display device may be a device configured to display visual and/or auditory media from one or more sources. For example, display device may be a television, smart television, computer monitor, etc. Examples of components that may provide media to display device 104 include but are not limited to: broadcast media 108 (e.g., such as a digital antenna, cable box, etc.), game console 112 (e.g., a computing device configured to execute video game applications which may be presented in whole or in part by display device 104. Users may interact with game console 112 using one or more game controllers 116, internet set-top 120 (e.g., a device configured to receive content from one or more remote networks such as the Internet and present the content using display device 104), etc.

Components may be connected to display device 104 through a wired (e.g., via an HDMI cable, optical cable, DisplayPort cable, USB cable, coaxial cable, digital antenna, etc.) or wireless connection (e.g., Wi-Fi, Bluetooth, etc.). In some instances, a component may be an application executed by display device 104 (e.g., such as a streaming application, etc.). Display device 104 may detect component connected display device 104 by detecting a signal over a particular input port. Display device 104 may determine when media to be presented is received over a particular input port. Display device 104 may execute a boundary detection process to determine a content type that corresponds to the media being presented. As a result, the display device may determine when display device 104 is presenting a television show, a movie, streaming content, a video game, etc. In some instances, display device 104 may identify the media being presented in response to determining a content type of the media (e.g., using an automated content recognition system, etc.)

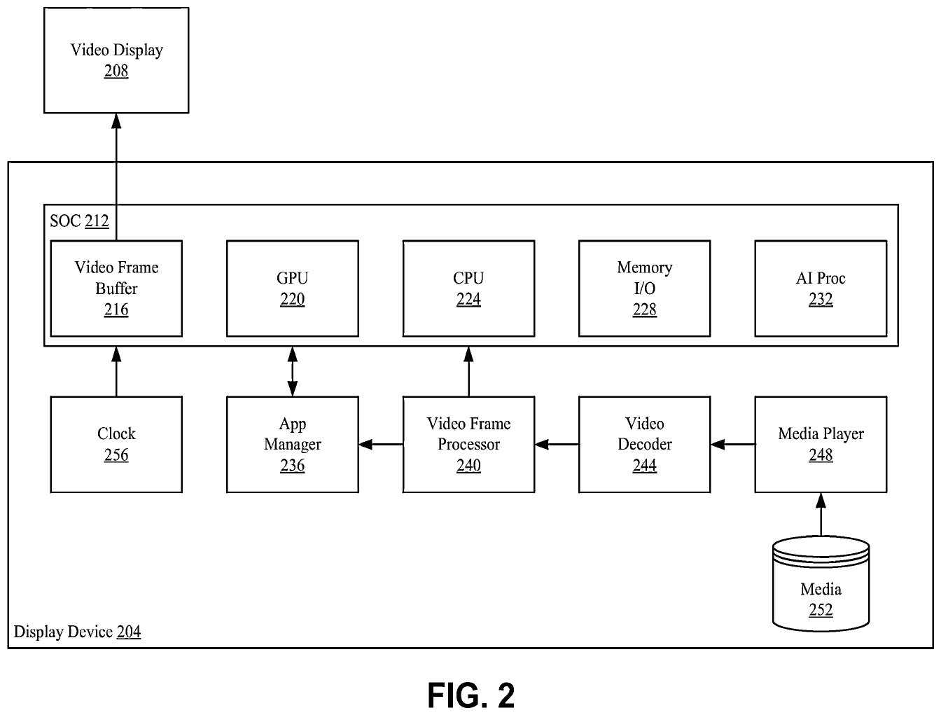

FIG. 2 illustrates a block diagram of an example computing device configured to detect boundaries associated with content being presented by a display device according to aspects of the present disclosure. Display device 204 may include one or processing components (e.g., system-on-a-chip, central processing units, application-specific integrated circuits, field programmable gate arrays, and/or the like), memories (e.g., volatile and non-volatile memories, databases, etc.), network processors (e.g., including Wi-Fi transceivers, Bluetooth transceivers, and/or other transceivers, etc.), and one or more sensors.

Display device 204 may be configured to present media to one or more users using display 208 and/or one or more wireless devices connected via a network processor (e.g., such as other display devices, mobile devices, tablets, and/or the like). Computing device 204 may retrieve the media from media database 252 (or alternatively receiving media from one or more broadcast sources, a remote source via a network processor, an external device, etc.). The media may be loaded by media player 248, which may process the media based on the container of the video (e.g., MPEG-4, QuickTime Movie, Wavefile Audio File Format, Audio Video Interleave, etc.). Media player 248 may pass the media to video decoder 244, which decodes the video into a sequence of video frames that can be displayed by display 208. The sequence of video frames may be passed to video frame processor 240 in preparation for display. Alternatively, media may be generated by an interactive service operating within app manager 236. App manager 236 may pass the sequence of frames generated by the interactive service to video frame processor 240.

The sequence of video frames may be passed to system-on-a-chip (SOC) 212. SOC 212 may include processing components configured to enable the presentation of the sequence of video components and/or audio components. SOC 212 may include central processing unit (CPU) 224, graphics processing unit (GPU) 220, volatile memories (e.g., random access memory), non-volatile memory (e.g., such as flash, etc.), input/output interfaces (e.g., collectively, the volatile memory, non-volatile memory, and input/output interfaces correspond to block 228), an artificial intelligence processor 232 (e.g., including one or more machine-learning models, training datasets, feature extractors, etc.), and video frame buffer 216.

SOC 212 may generate a cue from one or more video fames stored in video frame buffer 216 prior to or as the one or more video frames are presented by video display 208. A cue may be generated from one or more pixel arrays (also referred to as a pixel patch) of a video frame. A pixel patch can be any arbitrary shape or pattern such as (but not limited to) a y×z pixel array, including y pixels horizontally by z pixels vertically from the video frame. A pixel can include color values, such as a red, a green, and a blue value. For example, a pixel 306 is shown having Red-Green-Blue (RGB) color values. The color values for a pixel can be represented by an eight-bit binary value for each color. Other suitable color values that can be used to represent colors of a pixel include luma and chroma (Y, Cb, Cr, also called YUV) values or any other suitable color values.

The display device may derive a mean value for each pixel patch. The mean value may be a 24-bit data record representative of the pixel patch. The display device may generate the cue by aggregating the average value for each pixel patch and adding a timestamp that corresponds to the frame from which the pixel patches were obtained. The timestamp may correspond to epoch time (e.g., which may represent the total elapsed time in fractions of a second since midnight, Jan. 1, 1970), a predetermined start time, an offset time (e.g., from the start of a media being presented or when the display device was powered on, etc.), or the like. The cue may also include metadata, which can include any information about a media being presented, such as a program identifier, a program time, a program length, or any other information (if known).

In some examples, a cue may be derived from any number of pixels patches obtained from a single video frame. Increasing the quantity of pixel patches included in a cue increases the data size of the cue, which may increase the processing load of the display device and the processing load of one or more cloud networks that may operate to identify content. For example, a cue derived from 25 pixel patches may correspond to 600-bits of data (24-bits per pixel patch times 25 pixel patches) not including the timestamp and any metadata. Increasing the quantity of video patches obtained from a video frame may increase the accuracy of boundary detection and content identification at the expense of increasing the processing load. Decreasing the quantity of video patches obtained from a video frame may decrease the accuracy of boundary detection and content identification while also decreasing the processing load of the display device. The display device may dynamically determine whether to generate cues using more or less pixel patches based on a target accuracy and/or processing load of the display devices.

Display device 204 may pass the cue to a machine-learning model of AI processors 232. The machine-learning model may generate a prediction indicating whether the frame from which the cue was obtained represents content of a different type than one or more preceding cues (e.g., an immediately preceding cue, a mean generated from a set of previous cues, etc.). Display device 204 may execute one or more actions based on the predictions. For instance, display device 204 may modify operations of CPU 224 and/or GPU 220 to improve the presentation of media of the predicted content type and/or reduce resource consumption of the video display device.

In some instances, display device 204 may transmit cues to a server configured to match the cue to references cues stored in a reference database. The reference cues may be associated with an identified television program, movie, video game, song, etc. If the server identifies a matching reference cue, the identifier associated with the matching reference cue may correspond to the media being presented by display device 204.

In some instances, the detection of non-broadcast programming (e.g., content other OTA television, cable, etc.) may be used to reduce a processing load on the server. For example, if AI processor 232 predicts that the current cue corresponds to non-broadcast programming, display device 104 may transmit a communication to the server notifying the server that non-broadcast programming is being presented by display device 104. The server may instruct display device 104 to temporarily reduce the quantity of cues generated for a predetermined interval (e.g., reducing the frequency of cues from 10 per second to 1 every 30 seconds, etc.). Since the server is receive fewer cues for matching, the processing load of the server can be reduced while maintaining content identification operations. If AI processor 232 predicts that a new cue corresponds to broadcast programming, then display device 104 may notify the server and return to generating cues at the original frequency. When the predetermined time interval lapses regardless of whether AI processor 232 did or did not predict that a cue corresponds to broadcast programming, display device 104 may return to generating cues at the original frequency. If AI processor 232 later predicts that a cue corresponds to non-broadcast programming, the process may reoccur. As a result, display device 104 may reduce the processing load of the server when presenting non-broadcast media (e.g., such as a video game), which the server may not have references cues for identification purposes or may be directed to ignore.

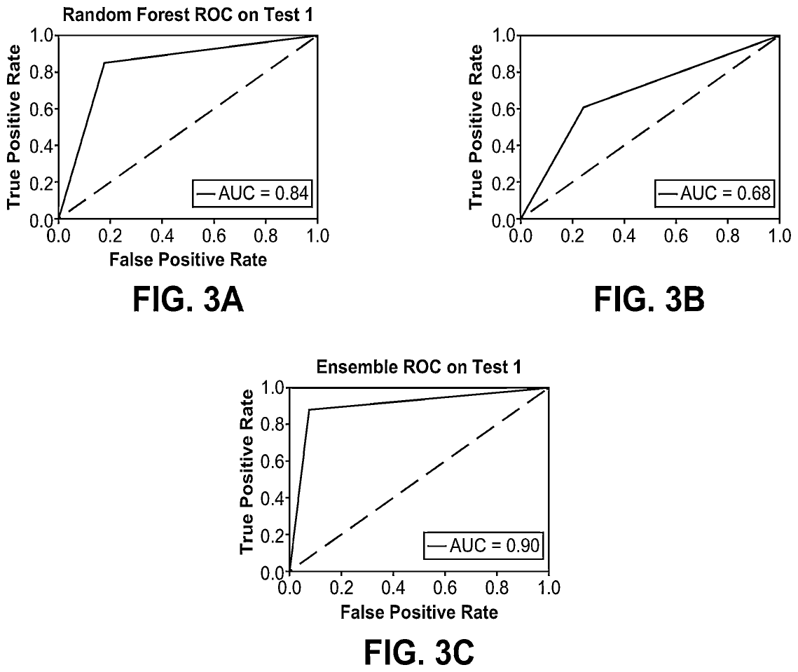

FIG. 3A illustrate a graph of an example random forest ROC of Test 1 according to aspects of the present disclosure. FIG. 3A depicts a graph representing an accuracy metric of a Random Forest machine-learning model. In which the false positive rate is graphed relative to the false positive rate. The area under the curve (AUC) represents an aggregate measure of performance across all possible classification thresholds of the machine-learning model. Thus, the AUC is an indicator of an accuracy of the Random Forest machine-learning model in predicting that a feature vector derived from a cue obtained from a video frame represents content of a particular content type. The AUC of the Random Forest machine-learning model for this test is 0.84.

FIG. 3B illustrate a graph of an example logistics regression ROC of Test 2 according to aspects of the present disclosure. FIG. 3B depicts a graph representing an accuracy metric of a logistic regression machine-learning model. The AUC represents an accuracy of the logistic regression machine-learning model in predicting that a feature vector derived from a cue obtained from a video frame represents content of a particular content type. The AUC of the logistic regression machine-learning model for this test is 0.68.

FIG. 3C illustrate a graph of an example ensemble ROC on Test 1 according to aspects of the present disclosure. FIG. 3B depicts a graph representing an accuracy metric of an ensemble machine-learning model comprising a random forest model and a logistic regression model. The AUC represents an accuracy of the ensemble machine-learning model in predicting that a feature vector derived from a cue obtained from a video frame represents content of a particular content type. The AUC of the ensemble machine-learning model for this test is 0.90 indicating, that for the test set, the ensemble model was better able to predict a content type associated with cues than the random forest and logistic regression models alone.

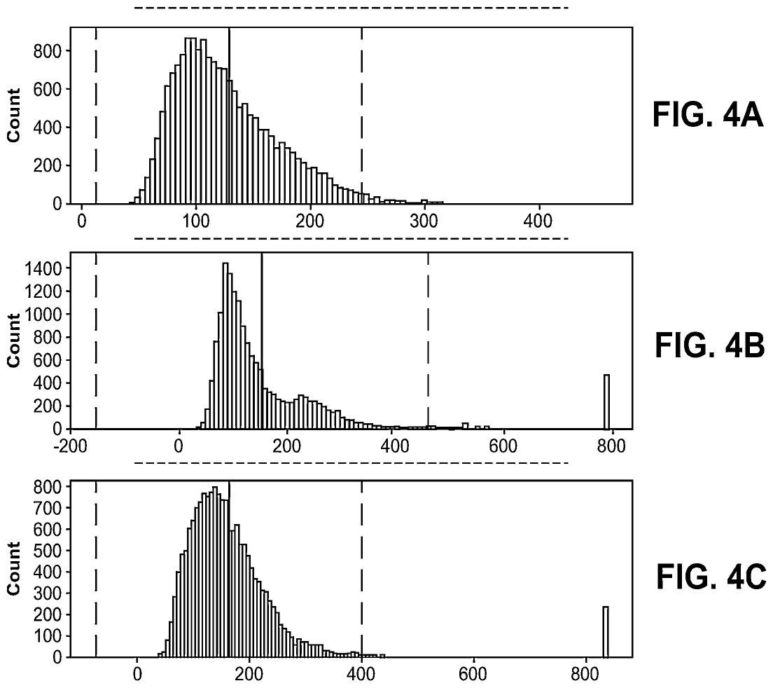

FIG. 4A-C illustrate histogram graphs of the distribution of distance from mean for different video games according illustrate to aspects of the present disclosure. The Rolling Average Model machine-learning model generates a probability based on the distance of a cue (or the features thereof) from the mean. The distribution of distances from the mean value indicates the sensitivity of the Rolling Average Model to detect that a new cue corresponds to a frame representing a particular video game (e.g., example video game 1 as shown in FIG. 4A, example video game 2 as shown in FIG. 4B, or example video game 3 as shown in FIG. 4C).

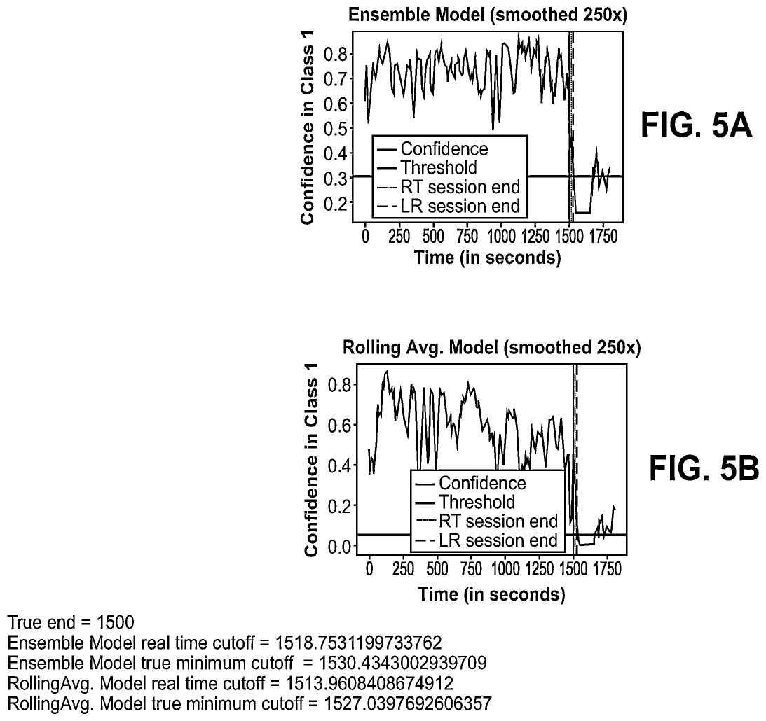

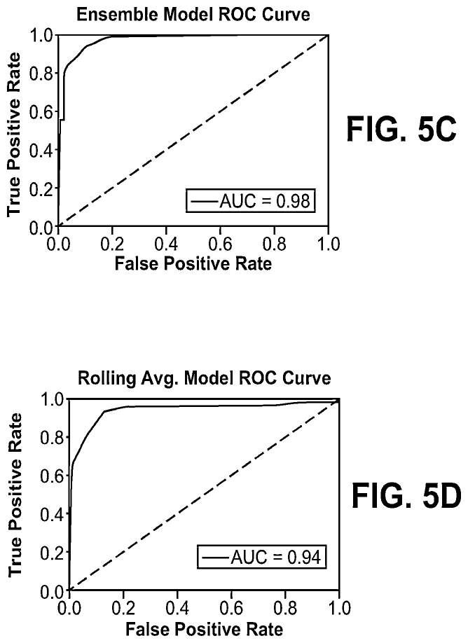

FIGS. 5A and 5B illustrate an example Ensemble Model (smoothed) and Rolling Average Model (smoothed) respectively and FIGS. 5C and 5D Ensemble Model ROC Curve and a Rolling Average Model ROC Curve respectively according to aspects of the present disclosure. The Ensemble Model (shown in FIG. 5A) compared to the Rolling Average Model (FIG. 5B) indicate that both models perform well when predicting a content type. In some examples, the Ensemble Model has a higher general accuracy. For example, the Ensemble Model has an AUC of 0.98 (as shown by the AUC in FIG. 5C) while the Rolling Average Model has an AUC of 0.94 (as shown by the AUC in FIG. 5D). The Rolling Average Model makes up for the slightly lower accuracy by being able to detect changes in content type faster than the Ensemble model. A display device may switch between the Ensemble Model and Rolling Average Model based on a calculated tradeoff between accuracy and speed.

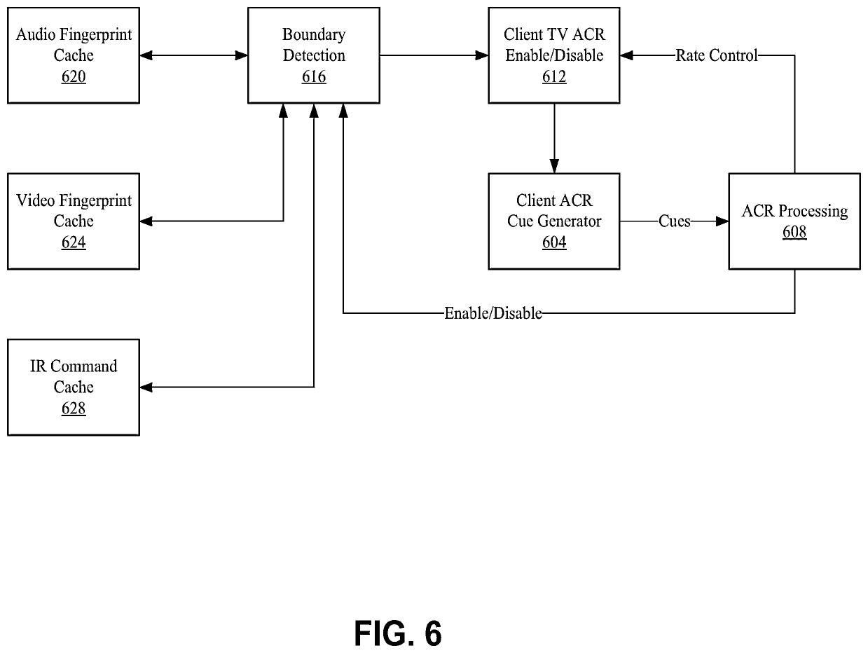

FIG. 6 illustrates a block diagram of a boundary detection system configured to detect boundaries between media of a first type and media of a second type according to aspects of the present disclosure. The boundary detection system may output a notification indicative of a boundary (e.g., a frame representing content of a different type than the immediately preceding frame). The boundary detection system may be a component of or operate with an automated content recognition (ACR) system of a display device. Client ACR cue generator 604 may generate cues from video frames stored within a video buffer. Client ACR cue generator 604 may generate cues at a default frequency (e.g., such as 10 cues per second, etc.). The default frequency may be determined by the ACR system, the display device, the machine-learning models (as previously described), user input, etc.).

The cues (e.g., corresponding to unknown media) may be passed to ACR processing 608. ACR processing 608 may determine if an unknown cue matches a reference cue of a reference database. Each reference cue may be associated with an identifier corresponding to a known media segment. When a match is found the identifier of the matching reference cue can be imputed onto the unknown cue (such that the unknown cue becomes a known cue).

Boundary detection 616 may receive cues from client ACR cue generator 604 and store coefficients derived from the cues in audio fingerprint cache 620, which stores coefficients corresponding to the audio component of a cue, video fingerprint cache 624 which stores coefficients corresponding to the video component of a cue, and/or infrared (IR) command cache 628 which stores indication of input from an infrared remote controller. In some instances, IR command cache 628 may store indication of input from other remote controllers (e.g., Bluetooth, wired controllers, etc.). IR command cache 628 may generate events when an input source of the display device is changed (e.g., such from coaxial input to an HDMI input, etc.) that may be indicative of a change in the content type being presented by the display device. Audio fingerprint cache 620, stores a predetermined quantity of audio coefficients from each of one or more cues. In some instances, audio fingerprint cache 620 may store 35 coefficients for each audio cue. Video fingerprint cache 624, may store a predetermined quantity of video coefficients from each of one or more cues. In some instances, video fingerprint cache 624 may store a larger quantity of video coefficients for each cue than the audio fingerprint cache 620. In those instances, video fingerprint cache 624 may store 75 coefficients per cue while audio fingerprint cache 620 may store 35. Coefficients per cue.

The coefficients for audio and video may be processed together or separately. When being processed together, the coefficients are aggregated together to form a feature vector to be passed as input in a machine-learning model (as previously described). When processed separately, the video coefficients may from a first feature vector and the audio coefficients may form a second feature vector. The machine-learning model may be trained to generate predictions according to a particular media type (e.g., video or audio). The display device may calibrate the machine-learning model to generate predictions from a given media type (e.g., the length of the lookback window, threshold for predictions, learning period to approximate the cluster or mean, etc.).

Boundary detection 616 may determine that a current video frame corresponds to content of a particular type (e.g., non-broadcast programming such as a video game, etc.). Since the ACR system is configured to identify broadcast sources, the ACR system may not include cues corresponding to non-broadcast sources. When the current content being displayed corresponds to non-broadcast programming, the ACR system can be paused or set to a reduced execution mode to avoid consuming processing resources attempting to identify a match for unknown cues for which there is no match. When a boundary is detected, boundary detection 616 may transmit a notification to ACR client TV ACR enable/disable 612 to cause ACR processing 608 to be disabled. Disabling ACR processing 608 causes client ACR cue generator 604 to generate cues at a reduced frequency. Returning to the previous example, at a reduced frequency client ACR cue generator 604 may generate 1 cue every 30 second. Client ACR processing 608 may continue to operate in the reduced execution mode for a predetermined time interval or until a frame is identified that corresponds to broadcast programing. For example, if ACR processing 608 identifies an unknown cue by matching it to a known reference cue while operating in reduced execution mode, then client ACR cue generator 604 may return to generating cues at the default frequency and boundary detection may be disabled for a predetermined time interval before continuing operations.

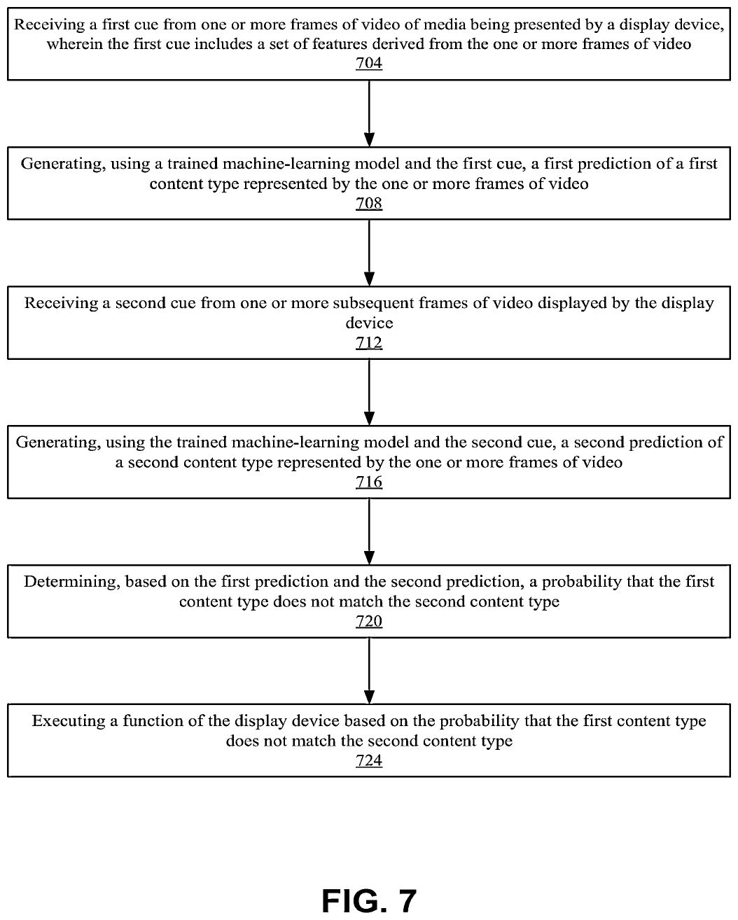

FIG. 7 illustrates a flowchart of an example process for detecting boundaries relative to linear programming according to aspects of the present disclosure. At block 704, a display device may receive a first cue representing one or more video frames of media being presented by the display device. The first cue may include a set of features derived from the one or more video frames. The set of features may represent characteristics of the one or more frames of video and/or characteristics of an audio segment corresponding to the one or more frames of video. In some instances, the display device may include a frame buffer as part of the processing pipeline of the display device. The display device may identify a particular one or more frames of video from the frame buffer and generate the cue from the one or more frames of video. Alternatively, the display device may receive the cue from a component of the display device (e.g., such an integrated system-on-a-chip (SOC), a device connected to the display device, a process executed by the display device, a process executed by another device connected to the display device, a remote process (e.g., executed by a server, via cloud network or service, etc.), from local or remote memory, and/or the like.

At block 708, the display device may generate a first prediction of a first content type represented by the one or more frames of video using a trained machine-learning model and the first cue. For example, the display device may define one or more feature vectors from the first cue and execute the machine-learning model using the one or more feature vectors as input. The machine-learning model may generate a prediction of a content type (e.g., video game, television show, movie, a streaming service, an advertisement or commercial, music, etc.) corresponding to the media being presented by the display device. The machine-learning model may also generate, with each prediction, a corresponding confidence value indicative of a degree the feature vector(s) of the first cue corresponds to the predicted output. The confidence value may be indicative of an accuracy of the prediction. If the machine-learning model generates multiple predictions for a given input cue, then the display device may select the prediction with a highest corresponding confidence value to be the output prediction.

The machine-learning model may be, but is not limited to, a clustering model (e.g., Naïve Bayes, K-Means, Mean-Shift, Density-Based Spatial Clustering, Gaussian Mixture Models, Agglomerative Hierarchical Clustering, etc.), a random forest model, a Rolling Average Classifier, support vector machine, Naïve Bayes, a logistic regression model, and an ensemble model including logistic regression model(s) and random forest model(s), neural network (e.g., a convolutional neural network, recurrent neural network, deep neural network), a deep learning network, etc. The machine-learning model may be trained using supervised learning, unsupervised learning, semi supervised learning, reinforcement learning, or the like based on the particular machine-learning model to be used, a type of output expected, and/or a target accuracy of the machine-learning model.

In some examples, the display device may execute one or more functions (as previously described) based on the predicted content type. For example, the display device may transmit a communication to a content server indicating that the display device is present content of a particular content type. Alternatively, or additionally, the display device may modify the display device to improve presentation of content corresponding to the display type. For instance, if the display device is presenting video game content, then the display device may increase the frame rate or response time of the display device to improve appearance of the display device and ability of a user to interact with the video game. If the display device is presenting music or streaming content, the display device may reduce the frame rate to reduce processing resource consumption, etc.

At block 712, the display device may receive a second cue representing one or more subsequent video frames displayed by the display device. The one or more video frames may be presented at some time instant after the one or more video frames. For example, the display device may receive cues periodically, in regular intervals, upon detection of an event (e.g., such as activation of a control of the display device, receiving instructions from a remote control, when the display device switches to an input source such as HDMI, when the display device is presented content from an input source, detection of a boundary, etc.), or the like.

In some instances, the display device may modify the regular interval (referred to as the modified time interval). For example, when an event is detected (e.g., such activation of a control of the display device, receiving instructions from a remote control, when the display device switches to an input source such as HDMI, when the display device is presented content from an input source, detection of a boundary, etc.), the display device may increase the rate in which cues are received for a predetermined time interval such as that if the display device regularly receives cues 10 cues every seconds, then in response detecting an event, the display device may receive 24 cues every second for the next predetermined time interval (e.g., 30 seconds, 1 minute, etc.). The regular time interval and the modified time interval may be predetermined or selected based on user input, the machine-learning model, the type of event detected, the content type currently being presented, and/or the like.

At block 716, the display device may generate a second prediction of a second content type represented by the one or more video frames using the machine-learning model and the second cue. In some instances, the display device may generate the prediction using a second machine-learning model in addition to or in place of the machine-learning model. The second machine-learning model may, for example, be a Rolling Average Classifier that uses naïve clustering to determine whether a new cue is distinct from (and therefor represents content of a different content type) previous cues. For example, the Rolling Average Classifier may define a mean value from a set of cues (or a mean value for each feature derived from each cue of the set of cues). The Rolling Average Classifier then determines for each new cue, the Euclidean distance the new cue is from the mean value (or values). A probability (e.g., confidence value, etc.) may be calculated that the new cue was obtained from a frame that corresponds to content of a different content type than the frames used to derive the mean value. The probability may be calculated based on the Euclidean distance or from z-score derived from the Euclidean distance. The probability may then be used to generate a prediction of whether the new cue was obtained from a frame representing content of a same type or a different type from previous frames. For example, if the probability is greater than a threshold, then the Rolling Average Classifier may predict that the new cue corresponds to a frame representing content of a new content type.

At block 720, the display device may determine, based on the first prediction and the second prediction, a probability that the first content type does not match the second content type by, for example, comparing the first prediction to the second prediction and, in some instances, the confidence value corresponding to the first prediction to the confidence value corresponding to the second prediction.

At block 724, the display device may execute one or more functions based on the probability that first content type does not match the second content type. The display device may execute any function (e.g., as previously described). In some instances, the particular one or more functions executed may be based on the particular content type associated with the probability. In other instances, the display device may select the one or more functions based on the particular content type associated with the probability and one or more of: characteristics of the machine-learning model (and/or second machine-learning model, predictions (or confidences or probabilities) generated by the machine-learning model (and/or the second machine-learning model), characteristics of the display device (e.g., a currently selected input source, input from a remote control, user input, settings of the display device, etc.), an identification of a preceding content type presented by the display device, historical content types presented by the display device, etc.).

For example, a function executed by the display device in response to detecting a single boundary (e.g., block 708, etc.) or two boundaries (e.g., block 708 and 716, etc.), may include modifying operations of an ACR system of the display device. The ACR system includes some processes that execute locally on the display device (e.g., such as cue generation, etc.) and some processes that execute remotely (e.g., such as cue matching, etc.). When the display device determines that the content being displayed is of a particular type (e.g., non-broadcast programming such as video games, etc.), the display device may temporarily modify the frequency with which cues are generated by the ACR system. Modifying the frequency may reduce the quantity of cues generated over a unit time interval, which may reduce the processing resources needed to process the cues to determine if there is a match. Reducing the frequency in which cues are generate reduces the processing resources of both the display device and the server.

In some instances, the display device may store a timestamp corresponding to each prediction that corresponds to a new content type. The display device may then determine a time interval over which content type was presented by the display device. The display device may transmit a report to a content server indicating one or more content types presented by the display device (e.g., a current content type and/or one or more immediately preceding content types, historical content types, etc.) along with the time interval corresponding to each content type.

The process of FIG. 7 may be executed locally on the processing hardware of the display device (e.g., an example of which is shown in FIG. 2). The process may be executed once, more than once, continuously, or the like. For example, the process of FIG. 1 may begin execution when the display device is powered on and continue to execute and recording boundaries until the display device is powered off.

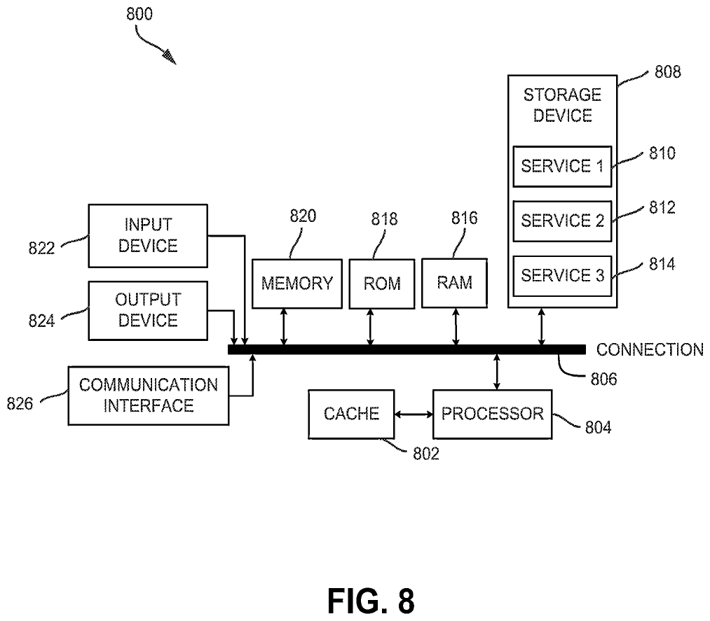

FIG. 8 illustrates an example computing device according to aspects of the present disclosure. For example, computing device 800 can implement any of the systems or methods described herein. In some instances, computing device 800 may be a component of or included within a media device. The components of computing device 800 are shown in electrical communication with each other using connection 806, such as a bus. The example computing device architecture 800 includes a processor (e.g., CPU, processor, or the like) 804 and connection 806 (e.g., such as a bus, or the like) that is configured to couple components of computing device 800 such as, but not limited to, memory 820, read only memory (ROM) 818, random access memory (RAM) 816, and/or storage device 808, to processing unit 810.

Computing device 800 can include a cache 802 of high-speed memory connected directly with, in close proximity to, or integrated within processor 804. Computing device 800 can copy data from memory 820 and/or storage device 808 to cache 802 for quicker access by processor 804. In this way, cache 802 may provide a performance boost that avoids delays while processor 804 waits for data. Alternatively, processor 804 may access data directly from memory 820, ROM 817, RAM 816, and/or storage device 808. Memory 820 can include multiple types of homogenous or heterogeneous memory (e.g., such as, but not limited to, magnetic, optical, solid-state, etc.).

Storage device 808 may include one or more non-transitory computer-readable media such as volatile and/or non-volatile memories. A non-transitory computer-readable medium can store instructions and/or data accessible by computing device 800. Non-transitory computer-readable media can include, but is not limited to magnetic cassettes, hard-disk drives (HDD), flash memory, solid state memory devices, digital versatile disks, cartridges, compact discs, random access memories (RAMs) 825, read only memory (ROM) 820, combinations thereof, or the like.

Storage device 808, may store one or more services, such as service 1 810, service 2 812, and service 3 814, that are executable by processor 804 and/or other electronic hardware. The one or more services include instructions executable by processor 804 to: perform operations such as any of the techniques, steps, processes, blocks, and/or operations described herein; control the operations of a device in communication with computing device 800; control the operations of processing unit 810 and/or any special-purpose processors; combinations therefor; or the like. Processor 804 may be a system on a chip (SOC) that includes one or more cores or processors, a bus, memories, clock, memory controller, cache, other processor components, and/or the like. A multi-core processor may be symmetric or asymmetric.

Computing device 800 may include one or more input devices 822 that may represent any number of input mechanisms, such as a microphone, a touch-sensitive screen for graphical input, keyboard, mouse, motion input, speech, media devices, sensors, combinations thereof, or the like. Computing device 800 may include one or more output devices 824 that output data to a user. Such output devices 824 may include, but are not limited to, a media device, projector, television, speakers, combinations thereof, or the like. In some instances, multimodal computing devices can enable a user to provide multiple types of input to communicate with computing device 800. Communications interface 826 may be configured to manage user input and computing device output. Communications interface 826 may also be configured to managing communications with remote devices (e.g., establishing connection, receiving/transmitting communications, etc.) over one or more communication protocols and/or over one or more communication media (e.g., wired, wireless, etc.).

Computing device 800 is not limited to the components as shown if FIG. 8. Computing device 800 may include other components not shown and/or components shown may be omitted.

The following examples illustrate various aspects of the present disclosure. As used below, any reference to a series of examples is to be understood as a reference to each of those examples disjunctively (e.g., “Examples 1-4” is to be understood as “Examples 1, 2, 3, or 4”).

Example 1 is a method comprising: receiving a first cue from one or more frames of video of media being presented by a display device, wherein the first cue includes a set of features derived from the one or more frames of video; generating, using a trained machine-learning model and the first cue, a first prediction of a first content type represented by the one or more frames of video; receiving a second cue from one or more subsequent frames of video being presented by the display device, wherein the second cue is received after the first cue; generating, using the trained machine-learning model and the second cue, a second prediction of a second content type represented by the one or more frames of video; determining, based on the first prediction and the second prediction, a probability that the first content type does not match the second content type; and executing a function of the display device based on the probability that the first content type does not match the second content type.

Example 2 is the method of example(s) 1, wherein one of the first and second content types corresponds to a video game.

Example 3 is the method of any of example(s) 1-2, wherein receiving the first cue from one or more frames of video of media being displayed by the display device includes: identifying one or more sets of pixels from a frame of video of the one or more frames of video; and extracting one or more features corresponding to pixel values from each of the one or more sets of pixels.

Example 4 is the method of any of example(s) 1-3, wherein the machine-learning model is an ensemble model derived from two or more machine-learning models.

Example 5 is the method of any of example(s) 1-4, wherein executing a function of the display device includes: facilitating a transmission to a server that includes an identification of the first content type and a duration of time over which the first content type is presented by the display device.

Example 6 is the method of any of example(s) 1-5, wherein generating the first prediction of the first content type represented by the one or more frames of video includes: identifying the media corresponding to the first content type.

Example 7 is the method of any of example(s) 1-6, further comprising: modifying the video display or audio settings of the display device, based on the first prediction and the first content type, to improve presentation of media corresponding to the first content type.

Example 8 is a system comprising: one or more processors; and a machine-readable storage medium storing instructions that when executed by the one or more processors, cause the one or more processors to perform operations including: receiving a first cue from one or more frames of video of media being presented by a display device, wherein the first cue includes a set of features derived from the one or more frames of video; generating, using a trained machine-learning model and the first cue, a first prediction of a first content type represented by the one or more frames of video; receiving a second cue from one or more subsequent frames of video being presented by the display device, wherein the second cue is received after the first cue; generating, using the trained machine-learning model and the second cue, a second prediction of a second content type represented by the one or more frames of video; determining, based on the first prediction and the second prediction, a probability that the first content type does not match the second content type; and executing a function of the display device based on the probability that the first content type does not match the second content type.

Example 9 is the system of example(s) 8, wherein one of the first and second content types corresponds to a video game.

Example 10 is the system of any of example(s) 8-9, wherein receiving the first cue from one or more frames of video of media being displayed by the display device includes: identifying one or more sets of pixels from a frame of video of the one or more frames of video; and extracting one or more features corresponding to pixel values from each of the one or more sets of pixels.

Example 11 is the system of any of example(s) 8-10, wherein the machine-learning model is an ensemble model derived from two or more machine-learning models.

Example 12 is the system of any of example(s) 8-11, wherein executing a function of the display device includes: facilitating a transmission to a server that includes an identification of the first content type and a duration of time over which the first content type is presented by the display device.

Example 13 is the system of any of example(s) 8-12, wherein generating the first prediction of the first content type represented by the one or more frames of video includes: identifying the media corresponding to the first content type.

Example 14 is the system of any of example(s) 8-13, herein the operations further include: modifying the video display or audio settings of the display device, based on the first prediction and the first content type, to improve presentation of media corresponding to the first content type.

Example 15 is a non-transitory machine-readable storage medium storing instructions that when executed by one or more processors, cause the one or more processors to perform operations including: receiving a first cue from one or more frames of video of media being presented by a display device, wherein the first cue includes a set of features derived from the one or more frames of video; generating, using a trained machine-learning model and the first cue, a first prediction of a first content type represented by the one or more frames of video; receiving a second cue from one or more subsequent frames of video being presented by the display device, wherein the second cue is received after the first cue; generating, using the trained machine-learning model and the second cue, a second prediction of a second content type represented by the one or more frames of video; determining, based on the first prediction and the second prediction, a probability that the first content type does not match the second content type; and executing a function of the display device based on the probability that the first content type does not match the second content type.

Example 16 is the non-transitory machine-readable storage medium of example(s) 15, wherein one of the first and second content types corresponds to a video game.

Example 17 is the non-transitory machine-readable storage medium of any of example(s) 15-16, wherein receiving the first cue from one or more frames of video of media being displayed by the display device includes: identifying one or more sets of pixels from a frame of video of the one or more frames of video; and extracting one or more features corresponding to pixel values from each of the one or more sets of pixels.

Example 18 is the non-transitory machine-readable storage medium of any of example(s) 15-17, wherein the machine-learning model is an ensemble model derived from two or more machine-learning models.

Example 19 is the non-transitory machine-readable storage medium of any of example(s) 15-18, wherein executing a function of the display device includes: facilitating a transmission to a server that includes an identification of the first content type and a duration of time over which the first content type is presented by the display device.

Example 20 is the non-transitory machine-readable storage medium of any of example(s) of example(s) 15-19, wherein generating the first prediction of the first content type represented by the one or more frames of video includes: identifying the media corresponding to the first content type.

Example 21 is the non-transitory machine-readable storage medium of any of example(s) 15-20, wherein the operations further include: modifying the video display or audio settings of the display device, based on the first prediction and the first content type, to improve presentation of media corresponding to the first content type.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving a first cue from one or more frames of video of media being presented by a display device, wherein the first cue includes a set of features derived from the one or more frames of video;
generating, using a trained machine-learning model and the first cue, a first prediction of a first content type represented by the one or more frames of video;
receiving a second cue from one or more subsequent frames of video being presented by the display device, wherein the second cue is received after the first cue;
generating, using the trained machine-learning model and the second cue, a second prediction of a second content type represented by the one or more frames of video;
determining, based on the first prediction and the second prediction, a probability that the first content type does not match the second content type; and
executing a function of the display device based on the probability that the first content type does not match the second content type.

2. The method of claim 1, wherein one of the first and second content types corresponds to a video game.

3. The method of claim 1, wherein receiving the first cue from one or more frames of video of media being displayed by the display device includes:
identifying one or more sets of pixels from a frame of video of the one or more frames of video; and
extracting one or more features corresponding to pixel values from each of the one or more sets of pixels.

4. The method of claim 1, wherein the machine-learning model is an ensemble model derived from two or more machine-learning models.

5. The method of claim 1, wherein executing a function of the display device includes:
facilitating a transmission to a server that includes an identification of the first content type and a duration of time over which the first content type is presented by the display device.

6. The method of claim 1, wherein generating the first prediction of the first content type represented by the one or more frames of video includes:
identifying the media corresponding to the first content type.

7. The method of claim 1, further comprising:
modifying the video display or audio settings of the display device, based on the first prediction and the first content type, to improve presentation of media corresponding to the first content type.

8. A system comprising:
one or more processors; and
a machine-readable storage medium storing instructions that when executed by the one or more processors, cause the one or more processors to perform operations including:
receiving a first cue from one or more frames of video of media being presented by a display device, wherein the first cue includes a set of features derived from the one or more frames of video;
generating, using a trained machine-learning model and the first cue, a first prediction of a first content type represented by the one or more frames of video;
receiving a second cue from one or more subsequent frames of video being presented by the display device, wherein the second cue is received after the first cue;
generating, using the trained machine-learning model and the second cue, a second prediction of a second content type represented by the one or more frames of video;
determining, based on the first prediction and the second prediction, a probability that the first content type does not match the second content type; and
executing a function of the display device based on the probability that the first content type does not match the second content type.

9. The system of claim 8, wherein one of the first and second content types corresponds to a video game.

10. The system of claim 8, wherein receiving the first cue from one or more frames of video of media being displayed by the display device includes:
identifying one or more sets of pixels from a frame of video of the one or more frames of video; and
extracting one or more features corresponding to pixel values from each of the one or more sets of pixels.

11. The system of claim 8, wherein the machine-learning model is an ensemble model derived from two or more machine-learning models.

12. The system of claim 8, wherein executing a function of the display device includes:
facilitating a transmission to a server that includes an identification of the first content type and a duration of time over which the first content type is presented by the display device.

13. The system of claim 8, wherein generating the first prediction of the first content type represented by the one or more frames of video includes:
identifying the media corresponding to the first content type.

14. The system of claim 8, herein the operations further include:
modifying the video display or audio settings of the display device, based on the first prediction and the first content type, to improve presentation of media corresponding to the first content type.

15. A non-transitory machine-readable storage medium storing instructions that when executed by one or more processors, cause the one or more processors to perform operations including:
receiving a first cue from one or more frames of video of media being presented by a display device, wherein the first cue includes a set of features derived from the one or more frames of video;
generating, using a trained machine-learning model and the first cue, a first prediction of a first content type represented by the one or more frames of video;
receiving a second cue from one or more subsequent frames of video being presented by the display device, wherein the second cue is received after the first cue;
generating, using the trained machine-learning model and the second cue, a second prediction of a second content type represented by the one or more frames of video;
determining, based on the first prediction and the second prediction, a probability that the first content type does not match the second content type; and
executing a function of the display device based on the probability that the first content type does not match the second content type.

16. The non-transitory machine-readable storage medium of claim 15, wherein one of the first and second content types corresponds to a video game.

17. The non-transitory machine-readable storage medium of claim 15, wherein receiving the first cue from one or more frames of video of media being displayed by the display device includes:
identifying one or more sets of pixels from a frame of video of the one or more frames of video; and
extracting one or more features corresponding to pixel values from each of the one or more sets of pixels.

18. The non-transitory machine-readable storage medium of claim 15, wherein the machine-learning model is an ensemble model derived from two or more machine-learning models.

19. The non-transitory machine-readable storage medium of claim 15, wherein executing a function of the display device includes:
facilitating a transmission to a server that includes an identification of the first content type and a duration of time over which the first content type is presented by the display device.

20. The non-transitory machine-readable storage medium of claim 15, wherein the operations further include:
modifying the video display or audio settings of the display device, based on the first prediction and the first content type, to improve presentation of media corresponding to the first content type.
